(19) United States
(12) Patent Application Publication
(10) Pub. No.: US 2007/0256751 A1
(43) Pub. Date: Nov. 8, 2007

(54) Corrugated Pipe Made of Thermoplastic Plastic

(75) Inventors: Michael Kellner, Rain (DE); Claus Hetzner, Zimdorf (DE)

Correspondence Address: FISH & RICHARDSON PC, P.O. BOX 1022, MINNEAPOLIS, MN, 55440-1022, US

(73) Assignee: DROSSBACH GMBH & CO. KG

(21) Appl. No.: 11/734,339

(22) Filed: Apr. 12, 2007

(30) Foreign Application Priority Data
Apr. 20, 2006 (DE) 10 2006 018 374.6

(51) Int. Cl. F16L 11/00

(52) U.S. Cl. 138/121; 138/122; 138/173; 138/177

(57) ABSTRACT

The present disclosure relates to a corrugated pipe made of thermoplastic plastic, which includes an inner pipe and a corrugated outer pipe connected thereto, wherein the profile of the outer pipe includes first sections with a first average diameter, second sections with a second average diameter greater than the first average diameter, and, disposed therebetween, flanks that connect the first sections to the respective adjacent second sections. The geometric relationships of the corrugated pipe are designed to yield not only high rigidity against pressure forces acting on the corrugated pipe in the radial direction and high flexibility with regard to bending of the corrugated pipe transversely to its longitudinal axis, but also, at the same time, a low weight in comparison to conventional corrugated pipes. This reduces the consumption of plastic during production and makes the corrugated pipe easier to handle when it is being laid.

### CROSS-REFERENCE TO RELATED APPLICATION

This application claims priority under 35 U.S.C. § 119 to DE 10 2006 018 374.6, filed Apr. 20, 2006, the contents of which are hereby incorporated by reference.

### FIELD

The present disclosure relates to corrugated pipes made of thermoplastic plastic.

### BACKGROUND

EP 0 385 465 B2 discloses a conduit pipe made of plastic, particularly for sewage, including a smooth inner pipe and, connected thereto, a corrugated outer pipe that can be connected via socket joints to a similar or single-walled, smooth conduit pipe.

EP 0 820 566 B1 discloses a multi-layer corrugated pipe, including a smooth inner pipe, a corrugated outer pipe and a layer of plastic between them.

### SUMMARY

The present disclosure provides an improved corrugated pipe that exhibits high rigidity against pressure forces acting on the corrugated pipe in the radial direction and high flexibility with regard to bending of the corrugated pipe transversely to its longitudinal axis, while simultaneously having as low a weight as possible. A low weight for the corrugated pipe means that less plastic is necessary to manufacture it and it is easier to handle when being laid.

In one aspect, the disclosure provides a corrugated pipe made of thermoplastic plastic. The corrugated pipe includes an inner pipe and, connected thereto, a corrugated outer pipe. The outer pipe includes first sections having a first average diameter and second sections having a second average diameter greater than the first average diameter. Disposed between the first and second sections are flanks that connect the first sections to the respective adjacent the second sections. The second sections have at least one region that is curved relative to the longitudinal direction of the corrugated pipe

In some embodiments, the corrugated pipe made of thermoplastic plastic includes an inner pipe and a corrugated outer pipe connected thereto, the profile of the outer pipe including first sections having a first average diameter, second sections having a second average diameter greater than the first average diameter, and, disposed therebetween, flanks that connect the first sections to the respective adjacent second sections. The first sections can be characterized as troughs, and the second sections, including the adjacent flanks, as crests.

In certain embodiments, the second sections—i.e., the peaks of the crests—are curved not only in the circumferential direction, but also relative to the longitudinal direction of the corrugated pipe, the convex side being directed either outward or inward. The radius of curvature, referring to the curvature of the second sections in the longitudinal direction of the corrugated pipe, is preferably smaller than the external diameter of the corrugated pipe, particularly less than ⅙ or 1/12 the external diameter of the corrugated pipe. It is particularly preferred if the center of curvature, referring to the curvature of the second sections in the longitudinal direction of the corrugated pipe, lies approximately on the wall of the inner pipe or in the region thereof.

In some embodiments, this conformation of the crests achieves the effect of high rigidity against pressure forces acting on the corrugated pipe in the radial direction, since the convex shape reduces the resistance of the corrugated pipe to buckling. At the same time, increased flexibility is gained with regard to bending of the corrugated pipe transversely to its longitudinal axis. This is because the convex shape of the crest allows the pipe, in the bent state, to be lengthened by extending the curvature on the tension side and shortened more easily by further compressing the curvature on the compression side, both with less exertion of force. As a result of these advantageous mechanical properties, the walls can thus be configured as thinner, such that the corrugated pipe can be implemented as considerably lighter than conventional corrugated pipes.

It can be particularly advantageous if the second sections each have a corrugated cross section—referring to a section in the longitudinal direction of the corrugated pipe—that has at least one inwardly directed convex side and at least two outwardly directed convex sides. Owing to the greater ease with which these sections can be lengthened or shortened, the corrugated pipe can easily be bent without lowering its rigidity against pressure forces acting on it in the radial direction. Each corrugated second sections can in this case have at least two crests and at least one trough, but particularly preferably three crests and two troughs.

It can be further advantageous if the transition regions between the second sections—i.e., the peaks of the crests—and the respective adjacent flanks also have a curvature relative to the longitudinal direction of the corrugated pipe that preferably has a smaller radius of curvature than the that of the second sections, i.e., the peaks of the crests. The same applies to the transition regions between the first sections—i.e., the troughs—and the respective adjacent flanks, although the radii of curvature of these transition regions should be configured as still smaller to avoid weakening the connection between the outer and the inner pipe in this region.

To further save on material, it can also be advantageous if the wall of the corrugated pipe in the axial region of the first sections—i.e., the troughs—is configured as smaller than the sum of the wall thickness of the respective second sections—i.e., the peaks of the crests—and the wall thickness of the inner pipe in the axial regions of the crests. It has proven particularly advantageous if the wall of the corrugated pipe in the axial regions of the first sections—i.e., the troughs—is equal to about 90% of that sum.

Also to economize on material, it is possible for the flanks to become thinner radially outward, particularly by at least 20-30%, from the flank wall adjoining the first section to the flank wall adjoining the second section.

According to a further aspect of the disclosure, the profile of the outer pipe can in part or in whole possess a parabolic shape, a cosine shape and/or an exponential shape. This is to be understood in particular as a conformation of the outer surface of the outer pipe that is parabolic, cosinusoidal and/or exponential in cross section and can be described by means of parabolic, cosine and/or exponential functions. Thus, depending on the choice of parameters for the corresponding functions, the profiles of the outer pipe can exhibit both high rigidity against pressure forces acting on the corrugated pipe in the radial direction and increased flexibility with regard to bending of the corrugated pipe transversely to its longitudinal axis.

As noted above, provided between each of the second sections—i.e., the peaks of the crests—and the respective adjacent flanks are respective second transition regions possessing a curvature relative to the longitudinal direction of the corrugated pipe. In like manner, also provided between each of the first sections—i.e., the troughs—and the respective adjacent flanks are respective first transition regions possessing a curvature relative to the longitudinal direction of the corrugated pipe.

In a first variant, the second sections, alone or together with the respective second transition regions, can have the shape of a parabolic function, a cosine function and/or an exponential function. In a second variant, the second sections, together with the respective second transition regions and, in part or in whole, the flanks, can have the shape of a parabolic function, a cosine function and/or an exponential function.

To give the outer pipe a symmetrical profile with respect to the crests and troughs, the first sections, alone or together with the respective first transition regions, can have the shape of the respective parabolic function, cosine function and/or exponential function reflected along the longitudinal axis of the corrugated pipe. In another variant, the first sections, together with the respective first transition regions and, in part or in whole, the flanks, can have the shape of the respective parabolic function, cosine function and/or exponential function reflected along the longitudinal axis of the corrugated pipe.

It should be noted that it may not be desirable in some applications for the outer pipe to have a symmetrical profile, since the radii of curvature of the first transition regions must be made smaller than the radii of curvature of the second transition regions to avoid weakening the connection between the outer and the inner pipe in this region. The shape of the respective parabolic function, cosine function and/or exponential function reflected along the longitudinal axis of the corrugated pipe can thus be compressed and/or distorted.

The profile of the outer pipe can have an imaginary coordinate system to which the parabolic function, cosine function and/or exponential function pertains. The origin of the imaginary coordinate system can lie at the maximum point of a second section—i.e., the peak of a crest—that is, the second section has its largest diameter at the maximum point. The x-direction can extend parallel to the longitudinal direction of the corrugated pipe and the y-direction parallel to the transverse direction of the corrugated pipe.

In some embodiments, the parabolic function can be the function y=−a|x^{m}| with the parameters a and m.

To provide scaling of the parameters that appear in the following discussion, the x- and y-values can be normalized to a value A representing the distance between two adjacent maximum points of the second sections, i.e., between the peaks of two adjacent crests.

In the case of a parabolic profile, the parameter a can be a positive real number, particularly a number in the range between 1 and 50, particularly between 2 and 20, particularly between 5 and 10. The parameter m in the case of a parabolic profile can represent a positive whole number greater than 1, particularly a number in the range between 2 and 10, particularly between 2 and 4, particularly m=2 or m=3.

In certain embodiments of the present disclosure, the cosine function can be the function y=cos (ax)^{m}−1 with the parameters a and m. Alternatively, the cosine function can also be represented by the function y=|cos (ax)^{m}|−1 with the parameters a and m. In the case of a cosine profile, the parameter a can be a positive real number, particularly a number in the range between 1 and 20, particularly between 3 and 10, particularly between 4 and 8. The parameter m in the case of a cosine profile can be a positive real number, particularly a number in the range between 1 and 10, particularly between 1 and 4, particularly m=1 or m=2.

If the outer pipe has an exponential profile, then, in some embodiments of the present disclosure, the exponential function can be the function y=e^{-a|x}^{^{m}}^{|}−1 with the parameters a and m.

In the case of an exponential profile, the parameter a can be a positive real number, particularly a number in the range between 1 and 100, particularly between 5 and 80, particularly between 10 and 50. The parameter m in the case of an exponential profile can represent a positive whole number, particularly a number in the range between 1 and 10, particularly between 1 and 5, particularly m=2 or m=4.

According to a further aspect of the present disclosure, the profile of the outer pipe can extend relative to the longitudinal direction of the corrugated pipe at least partially in a spiral or screw shape around the inner pipe, that is, the longitudinal extent of both the crests and the troughs around the circumference of the inner pipe is spiral- or screw-shaped, and not closed. This results both in high rigidity against pressure forces acting on the corrugated pipe in the radial direction and in increased flexibility with regard to bending of the corrugated pipe transversely to its longitudinal axis.

### BRIEF DESCRIPTION OF THE DRAWINGS

FIG. 1 shows a corrugated pipe made of thermoplastic plastic;

FIG. 2 shows a longitudinal cross section in the region of one of the crests of a corrugated pipe;

FIG. 3 shows a longitudinal cross section in the region of one of the crests of a corrugated pipe;

FIG. 4 shows two parabolic profiles of the outer pipe;

FIG. 5 shows two cosine profiles of the outer pipe;

FIG. 6 shows two exponential profiles of the outer pipe;

FIG. 7 shows a longitudinal cross section in the region of one of the crests of a corrugated pipe including an outer pipe having a parabolic profile;

FIG. 8 shows a longitudinal cross section in the region of two of the crests of a corrugated pipe including an outer pipe having a parabolic profile;

FIG. 9 shows a longitudinal cross section in the region of one of the crests of a corrugated pipe including an outer pipe having a cosine profile; and

FIG. 10 shows a longitudinal cross section in the region of two of the crests of a corrugated pipe including an outer pipe having a cosine profile.

### DETAILED DESCRIPTION

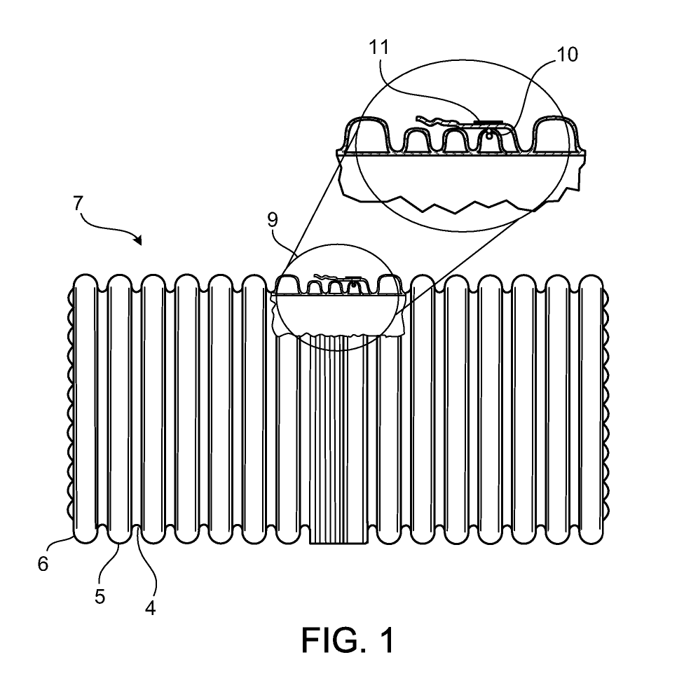

Illustrated in FIG. 1 is a plastic pipe 1 provided with a corrugated outer wall and a smooth inner wall and used in particular for sewer systems. The plastic pipe 1 preferably includes a socket or connector 9 for connection to another plastic pipe, the connector 9 being sealed by means of a seal 10. A reinforcing band 11 can be provided in the region of the seal 10 to prevent creep of the connector 9 in the region of the seal 10.

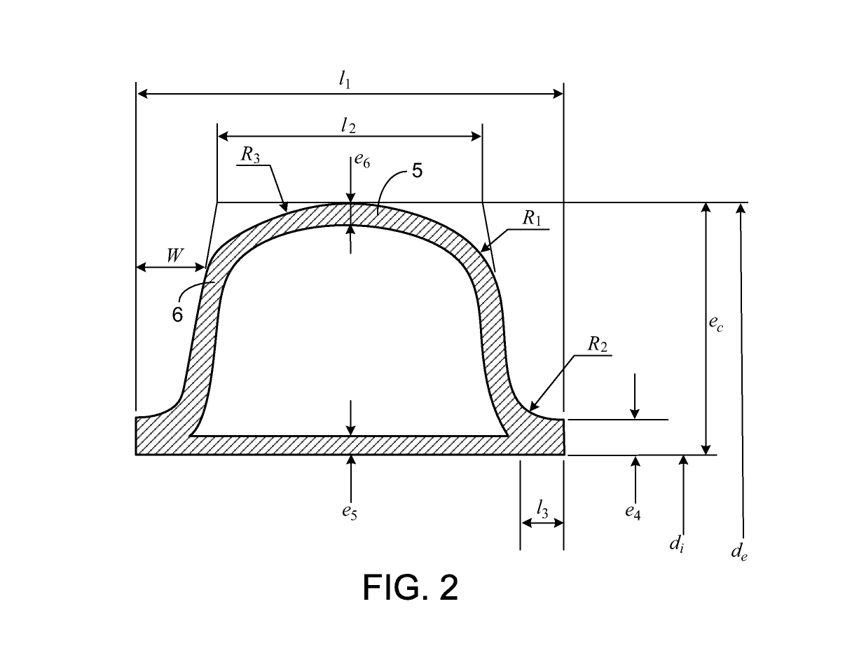

FIG. 2 shows a longitudinal cross section in the region of a crest of a corrugated pipe having an internal diameter dᵢ. The outer pipe alternatingly includes troughs or first sections 4 and crests, the latter being composed of two flanks 6 and a second section 5, i.e., the peak of the crest. Second sections 5 are curved, relative to the longitudinal direction of the corrugated pipe, with a radius of curvature R₃ (based on the outer surface of the outer pipe) that is approximately 1/18 the external diameter de of the corrugated pipe. Radius of curvature R₃ is approximately equal to the height e_{c} of a crest, in other words approximately ½ the difference between the external diameter de and the internal diameter dᵢ of the corrugated pipe. The center of curvature therefore lies approximately on the wall of the inner pipe.

In the exemplary embodiment illustrated in FIG. 2, the transition region between each second section 5—i.e., the peak of a crest—and the respective adjacent flanks 6 also has a curvature relative to the longitudinal direction of the corrugated pipe that has a radius of curvature R₁, based on the outer surface of the outer pipe. By contrast, the radius of curvature R₂ of the transition region between each first section—i.e., the troughs—and the respective adjacent flanks is only about ½ R₁.

To further economize on material for the production of the corrugated pipe, the wall e₄ of the corrugated pipe according to FIG. 2 is configured as smaller in the axial region of the first sections 4—i.e., the troughs—than the sum of the wall thickness e₆ of the second sections and the wall thickness e₅ of the inner pipe in the axial region of the crests (e₄<e₅+e₆). The wall of the corrugated pipe in the axial region of the first sections 4 is equal to only about 90% of that sum.

Also to save on material, it is possible for the flanks 6 to become thinner radially outward. In the exemplary embodiment according to FIG. 2, the flank wall adjoining the first section tapers approximately 30% to the flank wall adjoining the second section.

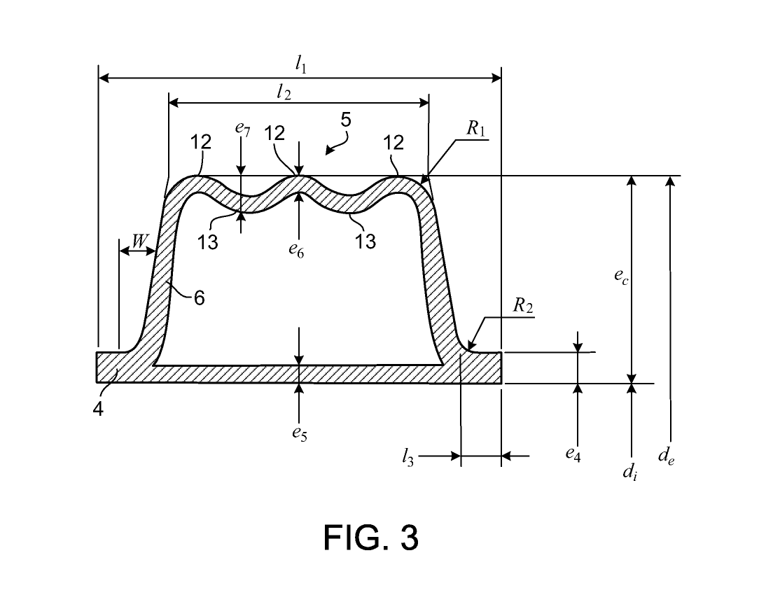

FIG. 3 shows a further exemplary embodiment of the present disclosure, in which the second section 5 itself also has a corrugated cross section in the longitudinal direction of the corrugated pipe. In the exemplary embodiment shown, second section 5 is composed of three crests 12 and two troughs 13. However, the second sections can also be composed of two crests and one trough, or four crests and three troughs. Should the corrugated pipe be bent, the lengthening or shortening of the corrugated second sections 5 is considerably facilitated by an “accordion effect” without decreasing the rigidity against pressure forces acting on the corrugated pipe in the radial direction.

In FIG. 3, the crests and troughs of the corrugated second sections each exhibit a directional change of approximately 75° before a mathematically positive curvature inverts to a mathematically negative curvature. Directional changes of only about 30° may also be provided, however. Nevertheless, the particularly preferred range is between about 50° and about 120°, particularly 60° to 90°.

The corrugated shape of the second sections 5 can also be expressed on the basis of the ratio of the wall thickness e₆ in the second section to the height difference e₇ between a crest 12 and a trough 13. In the exemplary embodiment illustrated in FIG. 3, the ratio e₇/e₆ is approximately 2, but ratios between 1.3 and 5, particularly between 1.5 and 3, may also be provided.

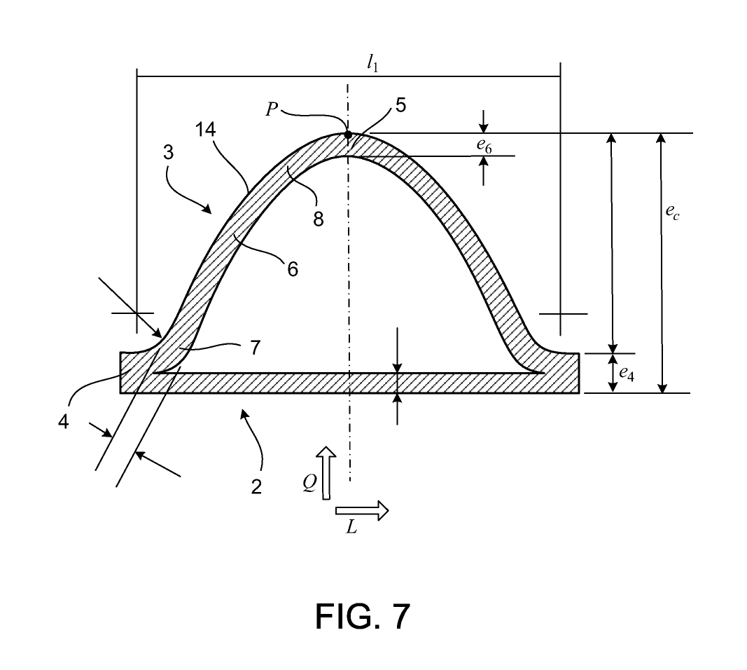

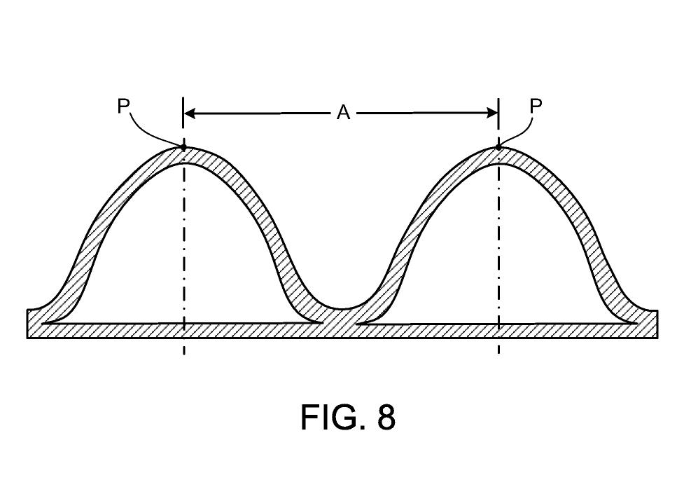

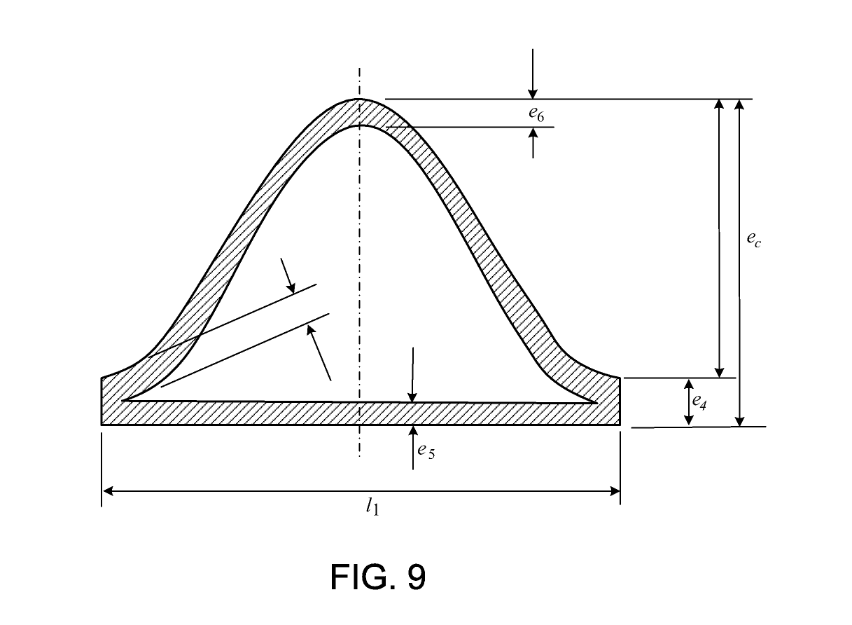

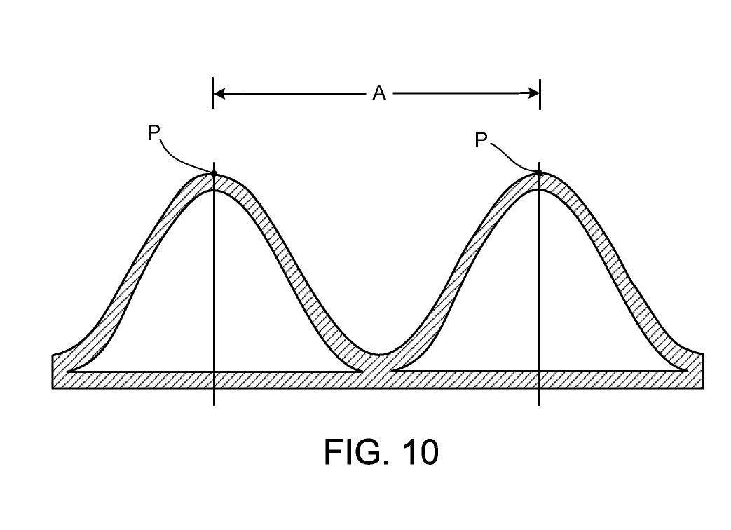

According to a further aspect of the disclosure, the profile of the outer pipe 3 can have a parabolic shape, a cosine shape and/or an exponential shape. This is to be understood in particular as meaning that the outer surface 14 of outer pipe 3 has a parabolic shape in cross section (as illustrated in FIGS. 7 and 8). Alternatively or cumulatively, the cross section can also be cosinusoidally and/or exponentially shaped. A cosine shape for the cross section is depicted in FIGS. 9 and 10.

The imaginary coordinate system to which the parabolic function, cosine function and/or exponential function pertains has its origin U at the maximum point P of a second section (the peak of a crest), i.e., the second section has its largest diameter at the maximum point (see FIG. 7). The x-direction can extend parallel to the longitudinal direction L of the corrugated pipe and the y-direction parallel to the transverse direction Q of the corrugated pipe.

To provide scaling of the parameters that appear in the following discussion, the x- and y-values can be normalized to a value A representing the distance between two adjacent maximum points of the second sections, i.e., between the peaks of two adjacent crests (see FIG. 8).

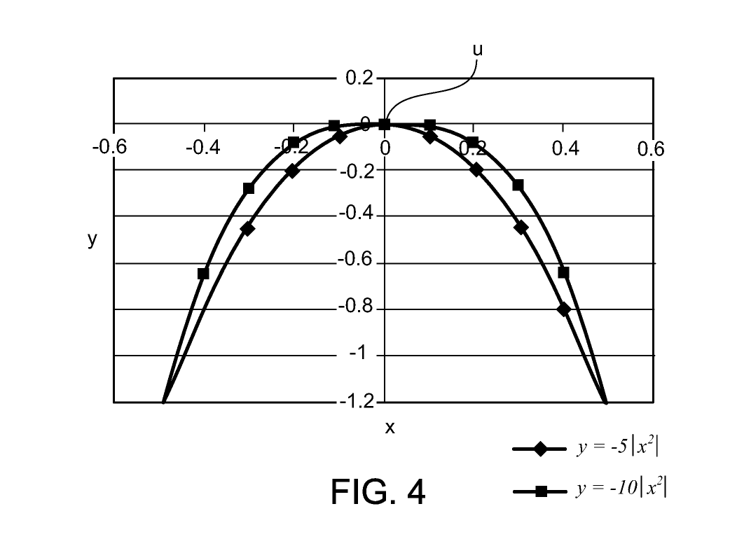

In the embodiment of the present disclosure illustrated in FIG. 4, the parabolic function is the function y=−a|x^{m}| with the parameters a and m; a first curve with the parameters a=5 and m=2 and a second curve with the parameters a=10 and m=3 are shown. However, it is expressly noted that the parameter a can be any positive real number, particularly a number in the range between 1 to [sic] 50, particularly between 2 and 20, particularly between 5 and 10. The parameter m can represent any positive whole number greater than 1, particularly a number in the range between 2 and 10, particularly between 2 and 4, particularly m=2 or m=3.

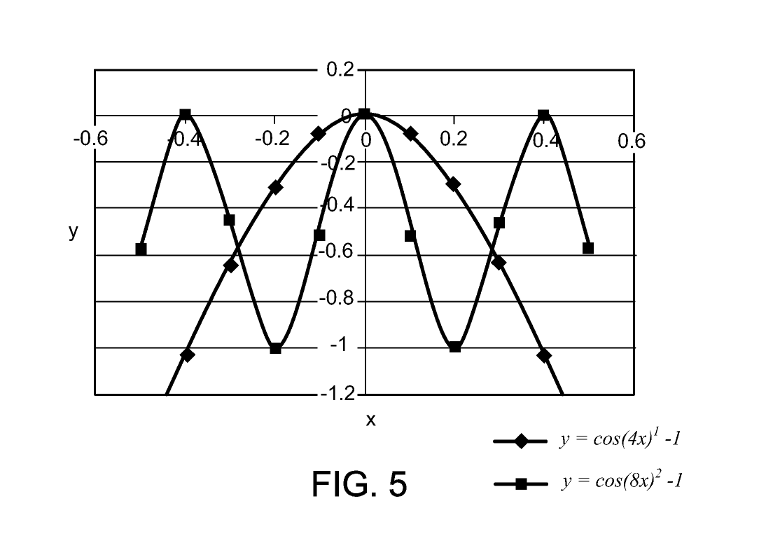

In the embodiment according to FIG. 5, the cosine function is represented by the function y=cos (ax)^{m}−1 with the parameters a and m. Alternatively, the cosine function can also be the function y=|cos (ax)^{m}|−1 with the parameters a and m. A first curve has the parameters a=4 and m=1. A second curve has the parameters a=8 and m=2. Once again, it is expressly noted that the parameter a can be any positive real number, particularly a number in the range between 1 and 20, particularly between 3 and 10, particularly between 4 and 8. The parameter m can represent any positive real number, particularly a number in the range between 1 and 10, particularly between 1 and 4, particularly m=1 or m=2.

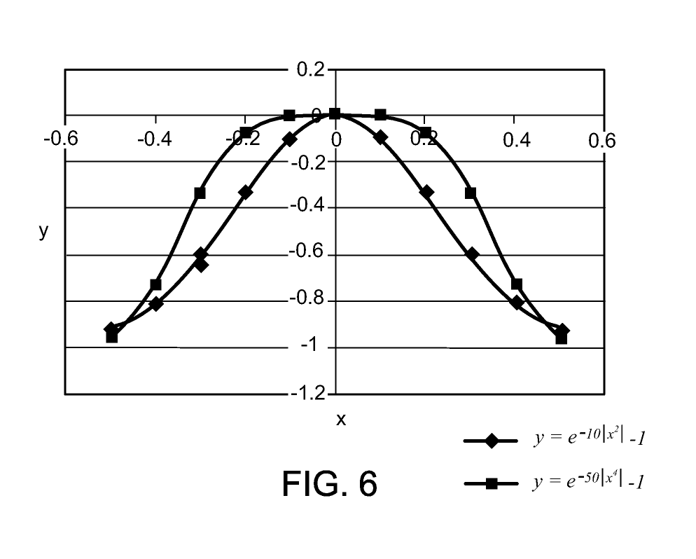

In some embodiments, the exponential function is the function y=e^{-a|x}^{^{m}}^{|}−1 with the parameters a and m. FIG. 6 presents a first such curve, with the parameters a=10 and m=2, and a second such curve, with the parameters a=50 and m=4. However, it is expressly noted here again that the parameter a can be any positive real number, particularly a number in the range between 1 and 100, particularly between 5 and 80, particularly between 10 and 50. The parameter m can represent any positive whole number, particularly a number in the range between 1 and 10, particularly between 1 and 5, particularly m=2 or m=4.

As illustrated in FIG. 7, provided between each of the second sections 5—i.e., the peaks of the crests—and the respective adjacent flanks 6 are respective second transition regions 8 possessing a curvature relative to the longitudinal direction L of the corrugated pipe 1. In like manner, also provided between each of the first sections 4—i.e., the troughs—and the respective adjacent flanks 6 are respective first transition regions 7 possessing a curvature relative to the longitudinal direction L of the corrugated pipe 1.

In a first variant, the second sections 5 can, alone or together with the respective second transition regions 8, have the shape of a parabolic function, a cosine function and/or an exponential function, as described above. In a second variant, the second sections 5 can, together with the respective second transition regions 8 and, in part or in whole, the flanks 6, have the shape of such a parabolic function, cosine function and/or exponential function.

To give the outer pipe a symmetrical profile with respect to the crests and troughs (see FIG. 10), the first sections 4, alone or together with the respective first transition regions 7, can have the shape of the respective parabolic function, cosine function and/or exponential function reflected along the longitudinal axis L of the corrugated pipe 1. In another variant, the first sections 4, together with the respective first transition regions 7 and, in part or in whole, the flanks 6, can have the shape of the respective parabolic function, cosine function and/or exponential function reflected along the longitudinal axis L of the corrugated pipe 1. In the embodiment depicted in FIG. 8, however, the shape of the respective parabolic function, cosine function and/or exponential function reflected along the longitudinal axis of the corrugated pipe is compressed or distorted.

It has been found that the corrugated pipe not only exhibits high rigidity against pressure forces acting on the corrugated pipe in the radial direction and high flexibility with regard to bending of the corrugated pipe transversely to its longitudinal axis, but at the same time has a low weight compared to conventional corrugated pipe. This reduces the consumption of plastic during production and makes the corrugated pipe easier to handle when it is being laid.

To provide scaling of the parameters that appear in the following discussion, the x- and y-values can be normalized to a value A representing the distance between two adjacent maximum points of the second sections, i.e., between the peaks of two adjacent crests.

In the case of a parabolic profile, the parameter a can be a positive real number, particularly a number in the range between 1 and 50, particularly between 2 and 20, particularly between 5 and 10. The parameter m in the case of a parabolic profile can represent a positive whole number greater than 1, particularly a number in the range between 2 and 10, particularly between 2 and 4, particularly m=2 or m=3.

In certain embodiments of the present disclosure, the cosine function can be the function y=cos (ax)^{m}−1 with the parameters a and m. Alternatively, the cosine function can also be represented by the function y=|cos (ax)^{m}|−1 with the parameters a and m.

In the case of a cosine profile, the parameter a can be a positive real number, particularly a number in the range between 1 and 20, particularly between 3 and 10, particularly between 4 and 8. The parameter m in the case of a cosine profile can be a positive real number, particularly a number in the range between 1 and 10, particularly between 1 and 4, particularly m=1 or m=2.

If the outer pipe has an exponential profile, then, in some embodiments of the present disclosure, the exponential function can be the function y=e^{-a|x}^{^{m}}^{|}−1 with the parameters a and m.

In the case of an exponential profile, the parameter a can be a positive real number, particularly a number in the range between 1 and 100, particularly between 5 and 80, particularly between 10 and 50. The parameter m in the case of an exponential profile can represent a positive whole number, particularly a number in the range between 1 and 10, particularly between 1 and 5, particularly m=2 or m=4.

According to a further aspect of the present disclosure, the profile of the outer pipe can extend relative to the longitudinal direction of the corrugated pipe at least partially in a spiral or screw shape around the inner pipe, that is, the longitudinal extent of both the crests and the troughs around the circumference of the inner pipe is spiral- or screw-shaped, and not closed. This results both in high rigidity against pressure forces acting on the corrugated pipe in the radial direction

1. A corrugated pipe made of thermoplastic plastic and comprising an inner pipe and, connected thereto, a corrugated outer pipe,
wherein the profile of the outer pipe includes:
first sections having a first average diameter;
second sections having a second average diameter greater than the first average diameter; and
disposed between the first and second sections, flanks that connect the first sections to the respective adjacent the second sections, and
wherein the second sections have at least one region that is curved relative to the longitudinal direction of the corrugated pipe.

2. The corrugated pipe as in claim 1, wherein the second sections are curved relative to the longitudinal direction of the corrugated pipe such that the convex side is directed outward.

3. The corrugated pipe as in claim 1, wherein the second sections are curved in the longitudinal direction of the corrugated pipe such that the convex side is directed inward.

4. The corrugated pipe as in claim 1, wherein the radius of curvature (R₃), referring to the curvature of the second sections in the longitudinal direction of the corrugated pipe, is distinctly smaller than the external diameter (dₑ) of the corrugated pipe.

5. The corrugated pipe as in claim 1, wherein the radius of curvature (R₃), referring to the curvature of the second sections in the longitudinal direction of the corrugated pipe, is equal to approximately ½ the difference between the external diameter (dₑ) of the corrugated pipe and the internal diameter (dᵢ) of the corrugated pipe.

6. The corrugated pipe as in claim 1, wherein the center of curvature (R₃), referring to the curvature of the second sections in the longitudinal direction of the corrugated pipe, is located approximately on the wall of the inner pipe or in the region thereof.

7. The corrugated pipe as in claim 1, wherein the second sections each have a corrugated cross section with at least one inwardly directed convex side and at least two outwardly directed convex sides.

8. The corrugated pipe as in claim 7, wherein the corrugated second sections have two inwardly directed convex sides and three outwardly directed convex sides.

9. The corrugated pipe as in claim 1, wherein provided between each of the second sections and the respective adjacent flanks are respective second transition regions possessing a curvature relative to the longitudinal direction of the corrugated pipe.

10. The corrugated pipe as in claim 1, wherein the radius of curvature (R₁) of the second transition regions is greater than ⅛ the difference between the external diameter (dₑ) of the corrugated pipe (1) and the internal diameter (dᵢ) of the corrugated pipe.

11. The corrugated pipe as in claim 1, wherein the radius of curvature (R₁) of the second transition regions is equal to approximately ⅙ the difference between the external diameter (dₑ) of the corrugated pipe and the internal diameter (dᵢ) of the corrugated pipe.

12. The corrugated pipe as in claim 1, wherein provided between the first sections and the respective adjacent the flanks are respective first transition regions possessing a curvature relative to the longitudinal direction of the corrugated pipe, the radius of curvature (R₂) being approximately ½ the radius of curvature (R₁) of the second transition regions relative to the longitudinal direction of the corrugated pipe.

13. The corrugated pipe as in claim 1, wherein the wall of each of the second sections or of each of the flanks is configured as thicker than the wall of the inner pipe in the axial region of the second sections.

14. The corrugated pipe as in claim 1, wherein the wall (e₄) of the corrugated pipe in the axial region of the first sections is configured as smaller than the sum of the wall thickness (e₆) of the second sections and the wall thickness (e₅) of the inner pipe in the axial region of the second sections.

15. The corrugated pipe as in claim 1, wherein the axial width of a crest composed of a second section and two adjacent flanks is approximately 1/10 the external diameter of the corrugated pipe.

16. The corrugated pipe as in claim 1, wherein the distance between two adjacent crests each composed of a the second section and two adjacent the flanks is approximately twice the height of the crest.

17. The corrugated pipe as in claim 1, wherein the flanks become thinner radially outward from the flank wall adjoining the first section to the flank wall adjoining the second section.

18. The corrugated pipe as in claim 1, wherein the flanks are inclined by an angle (W) with respect to a plane oriented perpendicular to the axis of the corrugated pipe.

19. The corrugated pipe as in claim 1, wherein the corrugated pipe is made of high-density polyethylene or of polypropylene.

20. The corrugated pipe as in claim 1, wherein the profile of the outer pipe has in part or in whole a parabolic shape, a cosine shape and/or an exponential shape.

21. The corrugated pipe as in claim 20, wherein provided between each of the second sections and the respective adjacent the flanks are respective second transition regions possessing a curvature relative to the longitudinal direction of the corrugated pipe, it being the case that the second sections, alone or together with the respective the second transition regions, have the shape of a parabolic function, a cosine function and/or an exponential function.

22. The corrugated pipe as in claim 20, wherein provided between each of the second sections and the respective adjacent the flanks are respective second transition regions possessing a curvature relative to the longitudinal direction of the corrugated pipe, it being the case that the second sections, together with the respective second transition regions and, in part or in whole, the flanks, have the shape of a parabolic function, a cosine function and/or an exponential function.

23. The corrugated pipe as in claim 20, wherein the profile of the outer pipe has an imaginary coordinate system of the parabolic function, cosine function and/or exponential function, it being the case that the origin of the imaginary coordinate system lies at the maximum point (P) of a second section, the second section has its largest diameter at the maximum point (P), and the x-direction extends parallel to the longitudinal direction of the corrugated pipe and the y-direction parallel to the transverse direction of the corrugated pipe.

24. The corrugated pipe as in claim 22, wherein the parabolic function is the function y=−a|x^{m}| with the parameters a and m.

25. The corrugated pipe as in claim 24, wherein the parameter a represents a positive real number, the x- and y-values being normalized to a value A representing the distance between two adjacent maximum points (P) of the second sections.

26. The corrugated pipe as in claim 24, wherein the parameter m represents a positive whole number greater than 1, the x- and y-values being normalized to a value A representing the distance between two adjacent maximum points (P) of the second sections.

27. The corrugated pipe as in claim 22, wherein the cosine function is the function y=cos (ax)^{m}−1 with the parameters a and m.

28. The corrugated pipe as in claim 22, wherein the cosine function is the function y=|cos (ax)^{m}|−1 with the parameters a and m.

29. The corrugated pipe as in claim 27, wherein the parameter a represents a positive real number, the x- and y-values being normalized to a value A representing the distance between two adjacent maximum points (P) of the second sections.

30. The corrugated pipe as in claim 27, wherein the parameter m represents a positive real number, the x- and y-values being normalized to a value A representing the distance between two adjacent maximum points (P) of the second sections.

31. The corrugated pipe as in claim 22, wherein the exponential function is the function
$$y = {ⅇ}^{- a \vert {x}^{m} \vert} - 1$$
with the parameters a and m.

32. The corrugated pipe as in claim 31, wherein the parameter a represents a positive real number, the x- and y-values being normalized to a value A representing the distance between two adjacent maximum points (P) of the second sections.

33. The corrugated pipe as in claim 31, wherein the parameter m represents a positive whole number, the x- and y-values being normalized to a value A representing the distance between two adjacent maximum points (P) of the second sections.

34. The corrugated pipe as in claim 21, wherein provided between each of the first sections and the respective adjacent the flanks are respective first transition regions possessing a curvature relative to the longitudinal direction of the corrugated pipe, it being the case that the first sections, alone or together with the respective first transition regions, have the shape of the parabolic function, cosine function and/or exponential function reflected and/or compressed along the longitudinal axis of the corrugated pipe.

35. The corrugated pipe as in claim 21, wherein provided between each of the first sections and the respective adjacent the flanks are respective first transition regions possessing a curvature relative to the longitudinal direction of the corrugated pipe, it being the case that the first sections, together with the respective first transition regions and, in part or in whole, the flanks, have the shape of the parabolic function, cosine function and/or exponential function reflected and/or compressed along the longitudinal axis of the corrugated pipe.

36. The corrugated pipe as in claim 1, wherein the profile of the outer pipe extends relative to the longitudinal direction of the corrugated pipe at least partially in a spiral or screw shape around the inner pipe.
